(19) United States
(12) Patent Application Publication
(10) Pub. No.: US 2013/0293526 A1
(43) Pub. Date: Nov. 7, 2013

(54) DISPLAY DEVICE AND METHOD OF OPERATING THE SAME

(71) Applicant: SAMSUNG DISPLAY CO., LTD., Yongin-City (KR)

(72) Inventor: MASAMI IGAWA, Suwon-si (KR)

(73) Assignee: SAMSUNG DISPLAY CO., LTD., Yongin-City (KR)

(21) Appl. No.: 13/715,887

(22) Filed: Dec. 14, 2012

(30) Foreign Application Priority Data
May 4, 2012 (KR) 10-2012-0047568

(51) Int. Cl. G09G 3/36

(52) U.S. Cl. CPC G09G 3/3696
USPC 345/212

(57) ABSTRACT

A display device includes pixels having gate lines, data lines, dummy pixels each of which is connected to a dummy gate line, a dummy data line or one of a corresponding data line of the data lines, a gate driver configured to drive the gate lines and the dummy gate line, a data driver configured to drive the data lines and the dummy data line, a timing controller configured to control the gate driver to drive the dummy gate line and apply a test data to the data driver during a test mode, a kickback detector configured to output a kickback signal corresponding to a difference between the test data and a digital detecting signal of the dummy pixel during the test mode, and a voltage generator adjusting a level of a common voltage in accordance with the kickback signal.

### CROSS-REFERENCE TO RELATED APPLICATION

This application claims under 35 U.S.C §119 benefit of and priority to Korean Patent Application No. 10-2012-0047568, filed on May 4, 2012, the disclosure of which is incorporated by reference herein.

### BACKGROUND

1. Field of the Invention

Embodiments of the invention generally relate to a display device and a method of operating the same. More particularly, the present disclosure relates to a display device capable of controlling a common voltage and a method of operating the display device.

2. Description of the Related Art

In general, a display device includes a display panel that displays an image and data drivers and gate drivers that drives the display panel. The display panel includes a plurality of gate lines, a plurality of data lines, and a plurality of sub-pixels. Each sub-pixel includes a switching transistor, a liquid crystal capacitor, and a storage capacitor. The data driver outputs gray-scale voltages to the data lines and the gate driver outputs a gate signal to the gate lines.

The display device applies a gate-on voltage to a gate electrode of the switching transistor connected to the gate line and applies the data voltage corresponding to an image to a source electrode of the switching transistor, thereby displaying a desired image. The data voltage applied to the liquid crystal capacitor and the storage capacitor while the switching transistor is turned on is required to be maintained during a predetermined time period after the switching transistor is turned off. However, the data voltage applied to the liquid crystal capacitor and the storage capacitor is distorted due to a parasitic capacitance between the gate and drain electrodes of the switching transistor.

The data voltage distorted by the parasitic capacitance is called a kickback voltage. Since image quality variation between frames increases as the kickback voltage becomes high, image-blurring phenomenon occurs. To decrease the kickback voltage, a method of lowering the gate-on voltage has been extensively used, but a driving capability of the switching transistor is deteriorated when the gate-on voltage is lowered.

### SUMMARY

The present disclosure provides a display device capable of compensating for a kickback voltage.

The present disclosure provides a method of operating the display device.

An embodiment of the invention is related to a display device includes a plurality of pixels arranged in a matrix array on a substrate, a plurality of dummy pixels each of which has a dummy gate line, and a dummy data line or one of a plurality of data lines, a gate driver configured to drive a plurality of gate lines and the dummy gate line, a data driver configured to drive the plurality of data lines and the dummy data line, a timing controller configured to control the gate driver to drive the dummy gate line and the data driver to drive the dummy data line, and configured to apply a test data to the data driver during a test mode, a kickback detector configured to output a kickback signal corresponding to a difference between the test data from the timing controller and detected voltage from the dummy pixel during the test mode; and a voltage generator configured to control a level of a common voltage in accordance with the kickback signal, wherein first dummy pixels of the plurality of dummy pixels are sequentially arranged in a direction in which the plurality of gate lines are extended and second dummy pixels of the plurality of dummy pixels are sequentially arranged in a direction in which the plurality of data lines are extended.

The timing controller controls the gate driver, the data driver and the kickback detector in response to an image signal and control signals during the test mode.

Each of the plurality of dummy pixels includes a dummy transistor connected to the one of a plurality of data lines or the dummy data line, a detecting line, and the dummy gate line, a dummy liquid crystal capacitor connected between the detecting line and the common voltage, and a dummy storage capacitor connected between the detecting line and the common voltage.

The dummy gate line includes a first dummy gate line connected to the first dummy pixels and a second dummy gate line connected to the second dummy pixels.

Each of the first dummy pixels of the plurality of dummy pixels includes a first dummy transistor connected to a corresponding data line of the plurality of data lines, a detecting line, and the first dummy gate line, a first dummy liquid crystal capacitor connected between the detecting line and the common voltage, and a first dummy storage capacitor connected between the detecting line and the common voltage. Each of the second dummy pixels of the plurality of dummy pixels includes a second dummy transistor connected to the dummy data line, the detecting line, and the second dummy gate line, a second dummy liquid crystal capacitor connected between the detecting line and the common voltage, and a second dummy storage capacitor connected between the detecting line and the common voltage.

The gate driver drives the first and the second dummy gate lines using a gate-on voltage and a gate-off voltage during the test mode, and the first and second dummy gate lines are substantially simultaneously driven.

The kickback detector includes a buffer including an input terminal connected to the detecting line and an output terminal, a switching circuit connected to the output terminal and configured to output a voltage of the output terminal of the buffer as an analog detecting voltage in response to a test mode signal from the timing controller, an analog-to-digital converter connected to the switching circuit and configured to convert the analog detecting voltage to a digital detecting signal, and a kickback output circuit connected to the analog-to-digital converter and configured to output a difference between the digital detecting signal and the test data as the kickback signal. The test mode signal is activated while the first and the second dummy gate lines are driven by the gate-off voltage.

The timing controller provides an image data to the data driver during the normal mode in response to an image signal and a control signal and provides a test data to the data driver during the test mode.

The display device further includes a gray-scale voltage generator configured to generate a plurality of gray-scale voltages, wherein the data driver drives the plurality of data lines and the dummy data line using a gray-scale voltage corresponding to the test data during the test mode. The analog-to-digital converter converts the analog detecting voltage to a digital detecting signal with reference to the gray-scale voltages from a gamma voltage generator.

An embodiment of the invention is related to a method of operating a display device, which includes applying a test data to a plurality of dummy pixels connected to a plurality of data lines and a dummy data line, driving a dummy gate line, detecting a voltage of a voltage detecting line to which the plurality of dummy pixels are commonly connected, converting the detected analog voltage of the voltage detecting line to a digital detecting signal, outputting a difference between the digital detecting signal and the test data as a kickback signal; and controlling a voltage level of a common voltage in accordance with the kickback signal. The method of operating a display device further includes comparing the digital detecting signal with the test data provided by the timing controller. The controlling a voltage level of a common voltage includes detecting a positive polarity analog detecting voltage and a negative polarity analog detecting voltage, and adjusting the common voltage to be a middle value of the positive polarity analog detecting voltage and a negative polarity analog detecting voltage.

The converting the detected analog voltage of the voltage detecting line to a digital detecting signal uses a look-up table or a gamma voltage generated by a gamma voltage generator.

According to the above, when the kickback voltage is detected, the voltage level of the common voltage may be controlled in accordance with the detected kickback voltage. Therefore, an image blurring phenomenon caused by the kickback voltage is reduced, and thus a display quality of the display device may be improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing a display device according to an exemplary embodiment of the present invention;

FIG. 2 is a circuit diagram showing an arrangement of pixels and dummy pixels of a display panel shown in FIG. 1;

FIG. 3 is a view showing a voltage level variation of a voltage detecting line in accordance with a signal variation of a gate line;

FIG. 4 is a view showing one dummy pixel connected to a kickback detector;

FIG. 5 is a view showing (m+n) dummy pixels connected to a kickback detector;

FIG. 6 is a view showing signals output from a buffer shown in FIG. 5 in a test mode;

FIG. 7 is a view showing an analog detecting voltage output from the buffer shown in FIG. 5 in accordance with a level of a common voltage generated by a voltage generator shown in FIG. 1;

FIG. 8 is a flowchart showing a method of operating a display device shown in FIG. 1 according to an exemplary embodiment of the present invention;

FIG. 9 is a block diagram showing a display device according to another exemplary embodiment of the present invention; and

FIG. 10 is a circuit diagram showing an arrangement of pixels and dummy pixels of a display panel shown in FIG. 9.

### DETAILED DESCRIPTION

Hereinafter, the present invention will be explained in detail with reference to the accompanying drawings.

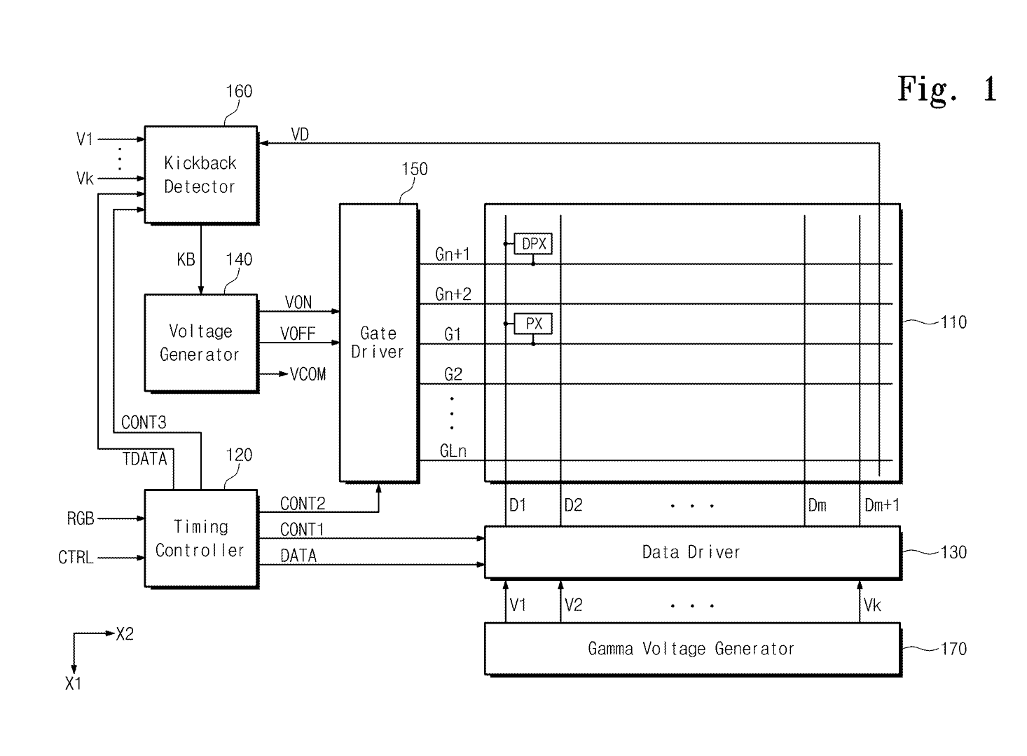

FIG. 1 is a block diagram showing a display device according to an exemplary embodiment of the present invention.

Referring to FIG. 1, a display device 100 includes a display panel 110, a timing controller 120, a data driver 130, a voltage generator 140, a gate driver 150, a kickback detector 160, and a gamma voltage generator 170.

The display panel 110 includes a plurality of data lines D1 to Dm, a dummy data line Dm+1, a plurality of gate lines G1 to Gn, and first and second dummy gate lines Gn+1 and Gn+2. The data lines D1 to Dm and the dummy data line Dm+1 are extended in a first direction X1. The gate lines G1 to Gn and the first and the second dummy gate lines Gn+1 and Gn+2 are extended in a second direction X2 to cross the data lines D1 to Dm and the dummy data line Dm+1. The display panel 110 further includes a plurality of pixels PX arranged in a matrix array and a plurality of dummy pixels DPX. The data lines D1 to Dm and the dummy data line Dm+1 are insulated from the gate lines G1 to Gn and the first and the second dummy gate lines Gn+1 and Gn+2. The configuration and arrangement of the pixels PX and the dummy pixels DPX will be described in detail later.

The timing controller 120 receives image signals RGB and control signals CTRL, such as a vertical synchronization signal, a horizontal synchronization signal, a main clock signal, and a data enable signal, etc., to control the image signals RGB. During a normal mode, the timing controller 120 applies images data DATA obtained by processing the images signals RGB appropriate to an operation condition of the display panel 110 on the basis of the control signals CTRL and a first control signal CONT1 to the data driver 130, and applies a second control signal CONT2 to the gate driver 150. The first control signal CONT1 includes a horizontal synchronization start signal, a clock signal, and a line latch signal. The second control signal CONT2 includes a vertical synchronization start signal, an output enable signal, a gate pulse signal, and a dummy enable signal.

The timing controller 120 controls the data driver 130, the gate driver 150, and the kickback detector 160 to allow the image to be displayed in the dummy pixels DPX during a test mode. In detail, the timing controller 120 provides test data TDATA to the data driver as the image data DATA and activates the dummy enable signal to drive the first and second dummy gate lines Gn+1 and Gn+2. In addition, the timing controller 120 applies the test data TDATA and a third control signal CONT3 to the kickback detector 160.

The gamma voltage generator 170 generates a plurality of gamma voltages V1 to Vk.

The data driver 130 drives the data lines D1 to Dm and the dummy data line Dm+1 using the gamma voltages V1 to Vk in response to the image data DATA and the first control signal CONT1 from the timing controller 120. The data drier 130 drives the data lines D1 to Dm during the normal mode and drives the data lines D1 to Dm and the dummy data line Dm+1 during the test mode.

The voltage generator 140 generates a gate-on voltage VON, a gate-off voltage VOFF, and a common voltage VCOM.

The gate driver 150 drives the gate lines G1 to Gn and the first and second dummy gate lines Gn+1 and Gn+2 using the gate-on voltage VON and the gate-off voltage VOFF from the voltage generator 140 in response to the second control signal CONT2 from the timing controller 120. The gate driver 150 drives only the gate lines G1 to Gn during the normal mode in which the dummy enable signal included in the second control signal CONT2 is in an inactivated state and drives only the first and second dummy gate lines Gn+1 and Gn+2 during the test mode in which the dummy enable signal is in an activated state. The gate driver 150 includes a gate driver IC. The gate driver IC may include an amorphous silicon gate (ASG) circuit using an amorphous-silicon thin film transistor (a-Si TFT).

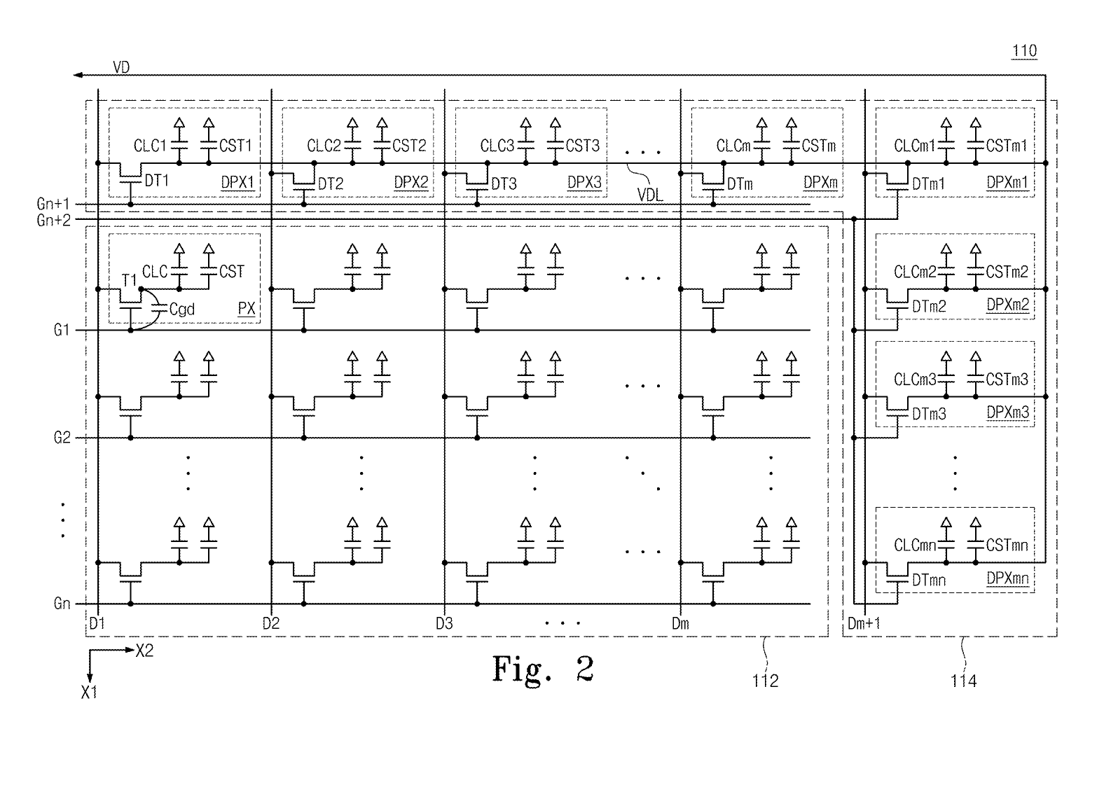

FIG. 2 is a circuit diagram showing an arrangement of pixels and dummy pixels of a display panel shown in FIG. 1.

Referring to FIG. 2, the display panel 110 includes a display area 112 in which the pixels PX are arranged and a dummy area 114 in which the dummy pixels DPX are arranged. In FIG. 2, the dummy area 114 is located on upper and right portions of the display area 112. The position of the dummy area 114 should not be limited to the upper and the right portions of the display area 112. For instance, the dummy area 114 may be located in upper and left portions, lower and left portions, lower and right portions, or upper and lower portions of the display area 112.

The display area 112 includes the pixels PX arranged in areas defined by the data lines D1 to Dm extended in the first direction X1 and the gate lines G1 to Gn extended in the second direction X2. Each pixel PX includes a switching transistor T1, a liquid crystal capacitor CLC, and a storage capacitor CST. The switching transistor T1 includes a source terminal connected to a corresponding data line of the data lines D1 to Dm, a drain terminal connected to the liquid crystal capacitor CLC and the storage capacitor CST, and a gate terminal connected to a corresponding gate line of the gate lines G1 to Gn. A first terminal of the liquid crystal capacitor CLC and the storage capacitor CST is connected to the drain terminal of the switching transistor T1. A second terminal of the liquid crystal capacitor CLC and the storage capacitor CST is connected to a common voltage VCOM of the voltage generator 140 shown in FIG. 1.

The dummy area 114 includes the dummy pixels DPX1 to DPXm and DPXm1 to DPXmn. Each of the plurality of dummy pixels DPX1 to DPXm has a dummy gate line, and a dummy data line, or one of a corresponding data line of the plurality of data lines D1 to Dm. The dummy pixels DPX1 to DPXm and DPXm1 to DPXmn are classified into first dummy pixels DPX1 to DPXm and second dummy pixels DPXm1 to DPXmn. The first dummy pixels DPX1 to DPXm are located in the upper portion of the display area 112 and sequentially arranged in the second direction X2 in which the first dummy gate line Gn+1 extends. The second dummy pixels DPXm1 to DPXmn are located in the right portion of the display area 112 and sequentially arranged in the first direction X1 in which the dummy data line Dm+1 extends.

Each of the first dummy pixels DPX1 to DPXm and each of the second dummy pixels DPXm1 to DPXmn include a dummy switching transistor, a dummy liquid crystal capacitor, and a dummy storage capacitor. For instance, the first dummy pixel DPX1 includes the dummy switching transistor DT1, the dummy liquid crystal capacitor CLC1, and the dummy storage capacitor CST1. The first dummy pixel DPX2 includes the dummy switching transistor DT2, the dummy liquid crystal capacitor CLC2, and the dummy storage capacitor CST2. The second dummy pixel DPXm1 includes the dummy switching transistor DTm1, the dummy liquid crystal capacitor CLCm1, and the dummy storage capacitor CSTm1. The second dummy pixel DPXmn includes the dummy switching transistor DTmn, the dummy liquid crystal capacitor CLCmn, and the dummy storage capacitor CSTmn.

Each of the dummy switching transistors DT1 to DTm of the first dummy pixels DPX1 to DPXm includes a source terminal connected to a corresponding data line of the data lines D1 to Dm, a drain terminal connected to a voltage detecting line VDL, and a gate terminal connected to the first dummy gate line Gn+1. A first terminal of each of the dummy liquid crystal capacitors CLC1 to CLCm and each of the dummy storage capacitors CST1 to CSTm of the first dummy pixels DPX1 to DPXm is connected to the voltage detecting line VDL, and a second terminal of each of the dummy liquid crystal capacitors CLC1 to CLCm and each of the dummy storage capacitors CST1 to CSTm of the first dummy pixels DPX1 to DPXm is connected to the common voltage VCOM generated by the voltage generator 140 shown in FIG. 1.

Each of the dummy switching transistors DTm1 to DTmn of the second dummy pixels DPXm1 to DPXmn includes a source terminal connected to the dummy data line Dm+1, a drain terminal connected to the voltage detecting line VDL, and a gate terminal connected to the second dummy gate line Gn+2. A first terminal of each of the dummy liquid crystal capacitors CLCm1 to CLCmn and each of the dummy storage capacitors CSTm1 to CSTmn of the second dummy pixels DPXm1 to DPXmn is connected to the voltage detecting line VDL, and a second terminal of each of the dummy liquid crystal capacitors CLCm1 to CLCmn and each of the dummy storage capacitors CSTm1 to CSTmn of the second dummy pixels DPXm1 to DPXmn is connected to the common voltage VCOM generated by the voltage generator 140 shown in FIG. 1. A detected voltage VD of the voltage detecting line VDL is applied to the kickback detector 160 shown in FIG. 1.

During the normal mode, the gate driver 150 shown in FIG. 1 sequentially applies the gate-on voltage VON to the gate lines G1 to Gn. During a time period in which the gate-on voltage VON is applied to one gate line, the switching transistors arranged in one row and connected to the one gate line are turned on, and the data driver 130 provides gray-scale voltages corresponding to the image data DATA to the data lines D1 to Dm. The gray-scale voltages provided to the data lines D1 to Dm are applied to corresponding pixels through the turned-on switching transistors. The period in which the switching transistors arranged in the one row are turned on, i.e., one period of a data enable signal and a gate clock signal, is called “one horizontal period” or “1H”. In addition, the period in which all gate lines G1 to Gn are driven once is called “one frame”

To prevent polarization of the liquid crystal material, the polarity of the cell voltage has to be reversed periodically. When the same polarity is continuously applied to the liquid crystal, electrical and physical properties of the liquid crystal layer are degraded. An inversion driving scheme, which reverses a polarity of a voltage applied to the pixel electrodes is extensively used.

As the inversion driving scheme, a pixel inversion driving scheme, a line inversion driving scheme, and a frame inversion driving scheme have been suggested. The frame inversion driving scheme reverses the polarity of gray-scale voltages applied to the pixels PX at every frame. That is, in a present frame, a gray-scale voltage higher than the common voltage VCOM, e.g., a positive (+) polarity gray-scale voltage, is applied to the first terminal of the liquid crystal capacitor CLC. In a subsequent frame, a gray-scale voltage lower than the common voltage VCOM, e.g., a negative (−) polarity gray-scale voltage, is applied to the first terminal of the liquid crystal capacitor CLC.

In the inversion driving scheme, the common voltage VCOM is set to an intermediate level between the positive (+) polarity gray-scale voltage and the negative (−) polarity gray-scale voltage. When the common voltage VCOM is biased to one of the positive (+) polarity gray-scale voltage and the negative (−) polarity gray-scale voltage, afterimage occurs. In addition, although the common voltage VCOM is set to an intermediate level between the positive (+) polarity gray-scale voltage and the negative (−) polarity gray-scale voltage, the common voltage VCOM may be shifted according to duration of the display device 100 and ambient temperature of the display device 100.

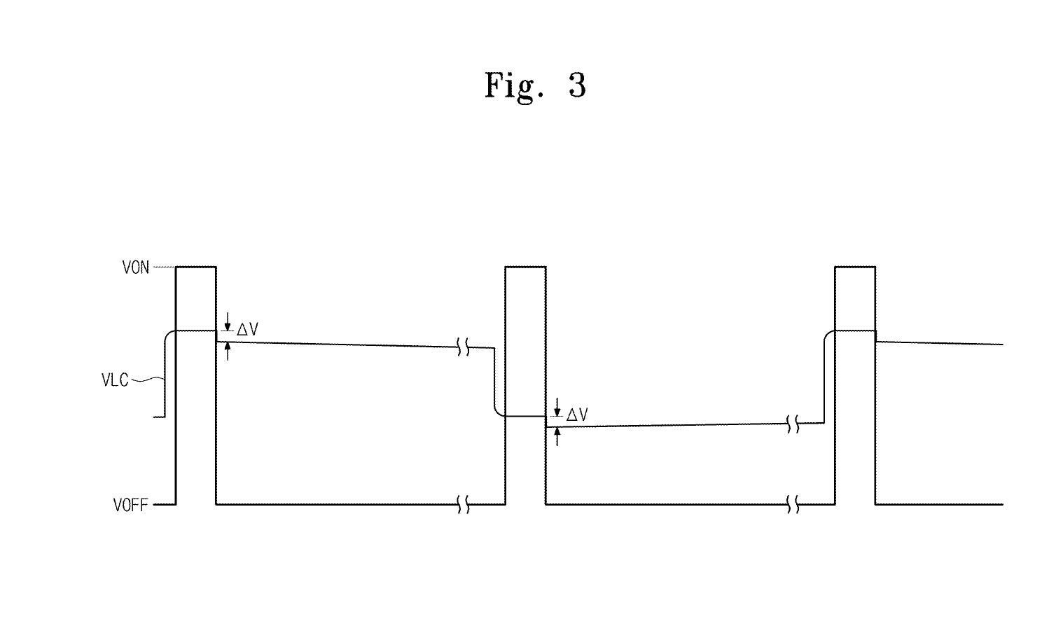

FIG. 3 is a view showing a voltage level variation of a voltage detecting line in accordance with a signal variation of a gate line.

In FIGS. 2 and 3, a voltage of the drain terminal of the switching transistor T1 is referred to as a pixel voltage VLC and a voltage applied to the source terminal of the switching transistor T1 through the corresponding data line is referred to as a data voltage Vsig.

The data voltage Vsig applies to the liquid crystal capacitor and the storage capacitor through the turned-on switching transistor T1 is required to be maintained in a predetermined time period after the switching transistor T1 is turned off. However, the pixel voltage VLC applied to the liquid crystal capacitor and the storage capacitor may be distorted by the parasitic capacitance Cgd existing between the gate electrode and the drain electrode. This distorted voltage is called a kickback voltage ΔV. Since image quality variation between frames increases as the kickback voltage ΔV increases, image-blurring phenomenon occurs.

The pixel voltage VLC satisfies the following Equation 1 when the switching transistor T1 is turned on.

VLC=Vsig Equation 1

The pixel voltage VLC satisfies the following Equation 2 when the switching transistor T1 is turned off.

VLC=Vsig−ΔV Equation 2

An electric charge Q(Cgd) of the parasitic capacitance Cgd satisfies the following Equation 3 when the switching transistor T1 is turned on.

Q(Cgd)=(VON−Vsig)×Cgd Equation 3

A sum of the electric charge Q(CLC+CST) of the liquid crystal capacitor CLC and the storage capacitor CST satisfies the following Equation 4 when the switching transistor T1 is turned on.

Q(CLC+CST)=(Vsig−VCOM)(CLC+CST) Equation 4

The electric charge Q(Cgd) of the parasitic capacitance Cgd satisfies the following Equation 5 when the switching transistor T1 is turned off.

Q(Cgd)=(VOFF−(Vsig−ΔV))×Cgd Equation 5

The sum of the electric charge Q(CLC+CST) of the liquid crystal capacitor CLC and the storage capacitor CST satisfies the following Equation 6 when the switching transistor T1 is turned off.

Q(CLC+CST)=(Vsig−ΔV−VCOM)(CLC+CST) Equation 6

On the assumption that the electric charge Q(Cgd) of the parasitic capacitance Cgd is uniform when the switching transistor T1 is turned on and off and the sum of the electric charge Q(CLC+CST) of the liquid crystal capacitor CLC and the storage capacitor CST is uniform when the dummy switching transistor DT1 is turned on and off, the following Equation 7 is established.

(VON−Vsig)×Cgd−{(Vsig−VCOM)(CLC+CST)}={VOFF−(Vsig−ΔV)}×Cgd−(Vsig−ΔV−VCOM)(CLC+CST) Equation 7

Therefore, the following Equation 8 is induced.

ΔV=Cgd×(VON−VOFF)/(CLC+CST+Cgd) Equation 8

Accordingly, when the kickback voltage ΔV is detected, the appropriate common voltage VCOM may be obtained in consideration of the kickback voltage ΔV. The dummy pixels DPX have the similar configuration as those of the pixels PX and are used to detect the kickback voltage ΔV.

Referring to back FIG. 2, during the test mode, the gate lines G1 to Gn are not driven and the first and second dummy gate lines Gn+1 and Gn+2 are driven. In the present exemplary embodiment, the first and second dummy gate lines Gn+1 and Gn+2 are substantially simultaneously driven by the gate-on voltage VON.

During the test mode, the data driver 130 shown in FIG. 1 applies the gray-scale voltages corresponding to the test data TDATA with reference to the gamma voltages V1 to Vk to the data lines D1 to Dm and the dummy data line Dm+1, thereby driving the data lines D1 to Dm and the dummy data line Dm+1. The test data TDATA may be gray-scale values that may be displayed in the display panel 110.

The voltage of the voltage detecting line VDL to which the dummy pixels DPX1 to DPXm and DPXm1 to DPXmn are commonly connected, i.e., the detected voltage VD, is provided to the kickback detector 160 shown in FIG. 1.

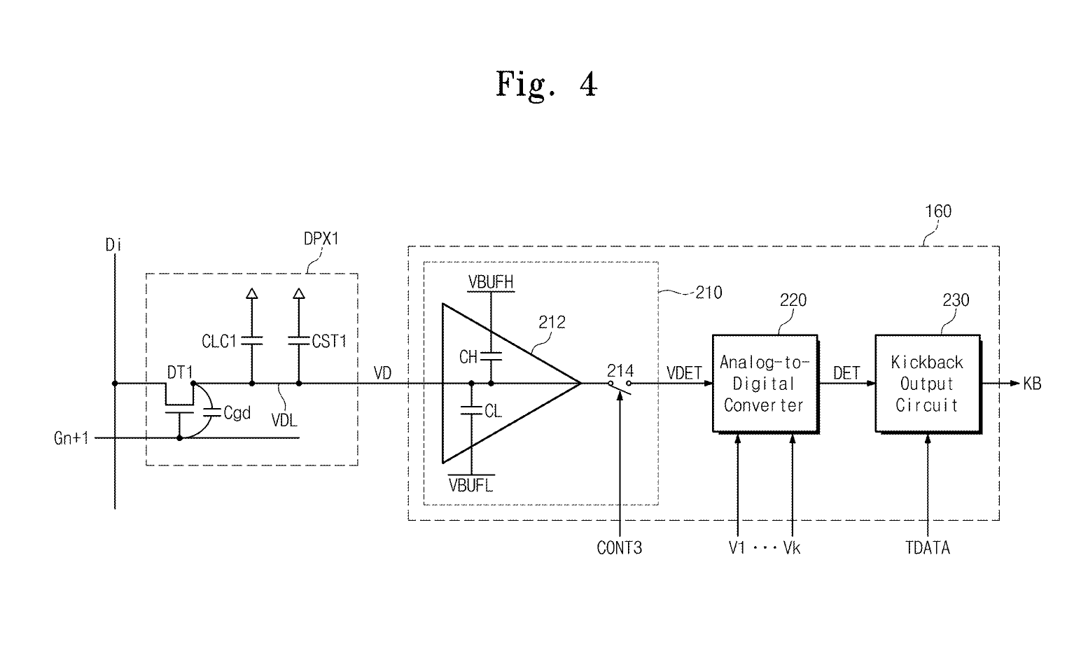

FIG. 4 is a view showing one dummy pixel connected to a kickback detector.

Referring to FIG. 4, the dummy pixel DPX1 includes a dummy switching transistor DT1, the dummy liquid crystal capacitor CLC1, and the dummy storage capacitor CST1. The dummy switching transistor DT1 includes a source terminal connected to the data line Di, a drain terminal connected to the voltage detecting line VDL, and a gate terminal connected to the first dummy gate line Gn+1. A first terminal of the dummy liquid crystal capacitor CLC1 and the dummy storage capacitor CST1 is connected to the voltage detecting line VDL and a second terminal of the dummy liquid crystal capacitor CLC1 and the dummy storage capacitor CST1 is connected to the common voltage VCOM generated by the voltage generator 140 shown in FIG. 1.

The detected voltage VD of the voltage detection line VDL of the dummy pixel DPX1 is input to a buffer circuit 210. The buffer circuit 210 applies an analog detecting voltage VDET to an analog-to-digital converter 220 in response to the third control signal CONT3.

The buffer circuit 210 includes a buffer 212 and a switch 214. The buffer 212 receives the detected voltage VD and the switch 214 outputs the output signal from the buffer 212 as the analog detecting voltage VDET in response to the third control signal CONT3.

The analog-to-digital converter 220 converts the analog detecting voltage VDET to a digital detecting signal DET using the gamma voltages V1 to Vk generated by the gamma voltage generator 170 shown in FIG. 1.

A kickback output circuit 230 compares the test data TDATA and the digital detecting signal DET and outputs a difference between the test data TDATA and the digital detecting signal DET as a kickback signal KB.

When assuming that a parasitic capacitance between the gate and drain terminals of the dummy switching transistor DT1 of the dummy pixel DPX1, a parasitic capacitance between a first voltage terminal VBUFH of the buffer 212 and the voltage detecting line VDL, and a parasitic capacitance between a second voltage terminal VBUFL and the voltage detecting line VDL are respectively referred to as Cgd, CH, and CL, the kickback voltage ΔV is obtained by the following process.

In the dummy pixel DPX1, a voltage of the drain terminal of the dummy switching transistor DT1 is referred to as a pixel voltage VLC and a voltage applied to the source terminal of the dummy switching transistor DT 1 through the data line D1 is referred to as a data voltage Vsig. The pixel voltage VLC satisfies the following Equation 9 when the dummy switching transistor DT1 is turned on.

VLC=Vsig Equation 9

The pixel voltage VLC satisfies the following Equation 10 when the dummy switching transistor DT1 is turned off.

VLC=Vsig−ΔV Equation 10

The electric charge Q(Cgd) of the parasitic capacitance Cgd satisfies the following Equation 11 when the dummy switching transistor DT1 is turned on.

Q(Cgd)=(VON−Vsig)×Cgd Equation 11

The sum of the electric charge Q(CLC+CST) of the liquid crystal capacitor CLC and the storage capacitor CST satisfies the following Equation 12 when the dummy switching transistor DT 1 is turned on.

Q(CLC+CST)=(Vsig−VCOM)(CLC+CST) Equation 12

The electric charges of the parasitic capacitances CH and CL respectively satisfy the following Equations 13 and 14 when the dummy switching transistor DT1 is turned on.

Q(CH)=(Vsig−VBUFH)×CH Equation 13

Q(CL)=(Vsig−VBUFL)×CL Equation 14

The electric charge Q(Cgd) of the parasitic capacitance Cgd satisfies the following Equation 15 when the dummy switching transistor DT1 is turned off.

Q(Cgd)=(VOFF−(Vsig−ΔV))×Cgd Equation 15

The sum of the electric charge Q(CLC+CST) of the liquid crystal capacitor CLC and the storage capacitor CST satisfies the following Equation 16 when the dummy switching transistor DT1 is turned off.

Q(CLC+CST)=(Vsig−ΔV−VCOM)(CLC+CST) Equation 16

The electric charges of the parasitic capacitances CH and CL respectively satisfy the following Equations 17 and 18 when the dummy switching transistor DT 1 is turned off.

Q(CH)=(Vsig−ΔV−VBUFH)×CH Equation 17

Q(CL)=(Vsig−ΔV−VBUFL)×CL Equation 18

On the assumption that the electric charge Q(Cgd) of the parasitic capacitance Cgd is uniform when the dummy switching transistor DT1 is turned on and off and the sum of the electric charge Q(CLC+CST) of the liquid crystal capacitor CLC and the storage capacitor CST is uniform when the dummy switching transistor DT1 is turned on and off, the following Equation 19 is established.

(VON−Vsig)×Cgd−{VOFF−(Vsig−ΔV)}×Cgd={(Vsig−VCOM)(CLC+CST)}+(Vsig−VL)×CL+(Vsig−VH)×CH−{(Vsig−ΔV−VCOM)(CLC+CST)}+(Vsig−ΔV−VL)×CL+(Vsig−ΔV−VH)×CH} Equation 19

In a case of Vsig−ΔV=A, Equations 19 is organized as the following Equation 20.

$$( VON - VOFF - Δ V ) \times Cgd = \{ ( Vsig - VCOM ) ( CLC + CST ) \} + ( Vsig - VL ) \times CL + ( Vsig - VH ) \times CH - \{ ( A - VCOM ) ( CLC + CST ) \} + ( A - VL ) \times CL + ( A - VH ) \times CH \} = ( Vsig - A ) ( CLC + CST ) + ( Vsig - A ) \times CL + ( Vsig - A ) \times CH = ( Vsig - A ) ( CLC + CST + CL + CH ) \qquad Equation 20$$

In case of A=Vsig−ΔV, Equation 20 is organized as the following Equation 21.

(VON−VOFF−ΔV)×Cgd=ΔV(CLC+CST+CL+CH) Equation 21

Therefore, the kickback voltage ΔV is induced as the following Equation 22.

ΔV=(VON−VOFF)×Cgd/(CLC+CST+CL+CH+Cgd) Equation 22

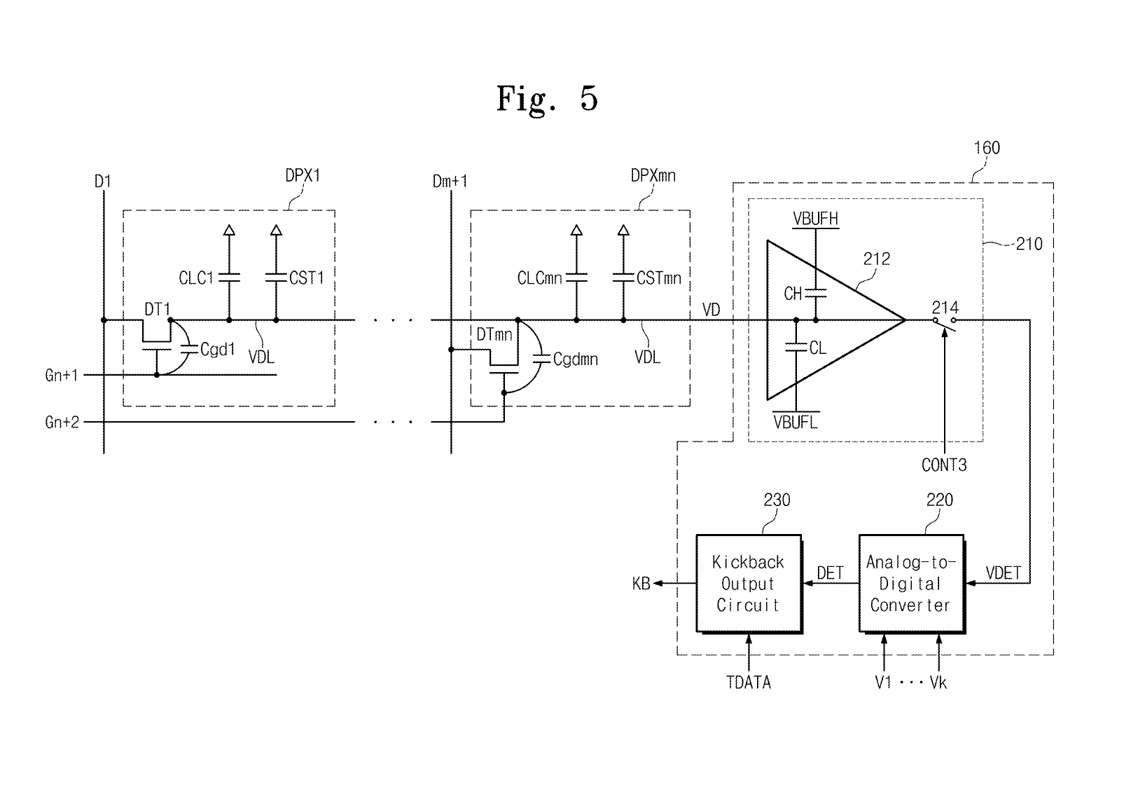

FIG. 5 is a view showing (m+n) dummy pixels connected to a kickback detector.

Referring to FIG. 5, the dummy pixel DPX1 includes the dummy switching transistor DT1, the dummy liquid crystal capacitor CLC1, and the dummy storage capacitor CST1. The dummy switching transistor DT1 includes the source terminal connected to the data line D1, the drain terminal connected to the voltage detecting line VDL, and the gate terminal connected to the first dummy gate line Gn+1. The first terminal of the dummy liquid crystal capacitor CLC1 and the dummy storage capacitor CST1 is connected to the voltage detecting line VDL and the second terminal of the dummy liquid crystal capacitor CLC1 and the dummy storage capacitor CST1 is connected to the common voltage VCOM generated by the voltage generator 140 shown in FIG. 1.

The dummy pixel DPXmn includes the dummy switching transistor DTmn, the dummy liquid crystal capacitor CLCmn, and the dummy storage capacitor CSTmn. The dummy switching transistor DTmn includes the source terminal connected to the dummy data line Dm+1, the drain terminal connected to the voltage detecting line VDL, and the gate terminal connected to the second dummy gate line Gn+2. The first terminal of the dummy liquid crystal capacitor CLCmn and the dummy storage capacitor CSTmn is connected to the voltage detecting line VDL and the second terminal of the dummy liquid crystal capacitor CLCmn and the dummy storage capacitor CSTmn is connected to the common voltage VCOM generated by the voltage generator 140 shown in FIG. 1.

The detected voltage VD of the voltage detection line VDL to which the dummy pixels DPX1 to DPXm and DPXm1 to DPXmn are commonly connected is input to the buffer circuit 210. The buffer circuit 210 applies the analog detecting voltage VDET to the analog-to-digital converter 220 in response to the third control signal CONT3.

The buffer circuit 210 includes a buffer 212 and a switch 214. The buffer 212 receives the detected voltage VD and the switch 214 outputs the output signal from the buffer 212 as the analog detecting voltage VDET in response to the third control signal CONT3.

The analog-to-digital converter 220 converts the analog detecting voltage VDET to the digital detecting signal DET using the gamma voltages V1 to Vk generated by the gamma voltage generator 170 shown in FIG. 1.

The kickback output circuit 230 compares the test data TDATA and the digital detecting signal DET and outputs the difference between the test data TDATA and the digital detecting signal DET as the kickback signal KB.

When assuming that the parasitic capacitance between the gate and drain terminals of the dummy switching transistor DT1 of the dummy pixel DPX1, the parasitic capacitance between the gate and drain terminals of the dummy switching transistor DTmn of the dummy pixel DPXmn, the parasitic capacitance between the first voltage terminal VBUFH of the buffer 212 and the voltage detecting line VDL, and the parasitic capacitance between the second voltage terminal VBUFL and the voltage detecting line VDL are respectively referred to as Cgd1, Cgdmn, CH, and CL, the kickback voltage ΔV′ is obtained by the following process.

In the dummy pixels DPX1 to DPXm and DPXm1 to DPXmn, a voltage of the drain terminal of each of the dummy switching transistors DT1 to DTm and DTm1 to DTmn is referred to as the pixel voltage VLC and a voltage applied to the source terminal of the dummy switching transistor DT1 through the corresponding data line is referred to as the data voltage Vsig. The pixel voltage VLC of each of the dummy switching transistors DT1 to DTm and DTm1 to DTmn satisfies the following Equation 23 when the dummy switching transistors DT1 to DTm and DTm1 to DTmn are turned on.

VLC=Vsig Equation 23

The pixel voltage VLC of each of the dummy switching transistors DT1 to DTm and DTm1 to DTmn satisfies the following Equation 24 when the dummy switching transistors DT1 to DTm and DTm1 to DTmn are turned off.

VLC=Vsig−ΔV′ Equation 24

The sum of the electric charge Q(Cgd) of the parasitic capacitances Cgd1 to Cgdm and Cgdm1 to Cgdmn satisfies the following Equation 25 when the dummy switching transistors DT1 to DTm and DTm1 to DTmn are turned on.

Q(Cgd)=(VON−Vsig)×Cgd1+(VON−Vsig)×Cgd2+ . . . +(VON−Vsig)×Cgdmn Equation 25

The sum of the electric charge Q(CLC+CST) of the liquid crystal capacitors CLC1 to CLCm and CLCm1 to CLCmn and the storage capacitors CST1 to CSTm and CSTm1 to CSTmn satisfies the following Equation 26 when the dummy switching transistors DT1 to DTm and DTm1 to DTmn are turned on.

Q(CLC+CST)=(Vsig−VCOM)(CLC1+CST1)+ . . . +(Vsig−VCOM)(CLCm1+CSTmn) Equation 26

The electric charges of the parasitic capacitances CH and CL respectively satisfy the following Equations 27 and 28 when the dummy switching transistor DT1 to DTm and DTm1 to DTmn are turned on.

Q(CH)=(Vsig−VBUFH)×CH Equation 27

Q(CL)=(Vsig−VBUFL)×CL Equation 28

The sum of the electric charge Q(Cgd) of the parasitic capacitances Cgd1 to Cgdm and Cgdm1 to Cgdmn satisfies the following Equation 29 when the dummy switching transistors DT1 to DTm and DTm1 to DTmn are turned off.

Q(Cgd)=(VOFF−(Vsig−ΔV′))×Cgd1+(VOFF−(Vsig−ΔV′))×Cgd2+ . . . +(VOFF−(Vsig−ΔV′))×Cgdmn Equation 29

The sum of the electric charge Q(CLC+CST) of the liquid crystal capacitors CLC1 to CLCm and CLCm1 to CLCmn and the storage capacitors CST1 to CSTm and CSTm1 to CSTmn satisfies the following Equation 30 when the dummy switching transistors DT1 to DTm and DTm1 to DTmn are turned off.

Q(CLC+CST)=(Vsig−ΔV′−VCOM)(CLC1+CST1)+ . . . +(Vsig−ΔV′−VCOM)(CLCm1+CSTmn) Equation 30

The electric charges of the parasitic capacitances CH and CL respectively satisfy the following Equations 31 and 32 when the dummy switching transistors DT1 to DTm and DTm1 to DTmn are turned off.

Q(CH)=(Vsig−ΔV′−VBUFH)×CH Equation 31

Q(CL)=(Vsig−ΔV′−VBUFL)×CL Equation 32

On the assumption that the electric charge Q(Cgd) of the parasitic capacitances Cgd1 to Cgdm and Cgdm1 to Cgdmn is uniform when the dummy switching transistors DT1 to DTm and DTm1 to DTmn are turned on and off and the sum of the electric charge Q(CLC+CST) of the liquid crystal capacitors CLC1 to CLCm and CLcm1 to CLCmn and the storage capacitors CST1 to CSTm and CSTm1 to CSTmn is uniform when the dummy switching transistors DT1 to DTm and DTm1 to DTmn are turned on and off, the following Equation 33 is established.

(VON−Vsig)×Cgd1+ . . . +(VON−Vsig)×Cgdmn−{(VOFF−(Vsig−ΔV′))×Cgd1+ . . . +(VOFF−(Vsig−ΔV′))×Cgdmn}={(Vsig−VCOM)(CLC1+CST1)+ . . . +(Vsig−VCOM)(CLCmn+CSTmn)}+(Vsig−VL)×CL+(Vsig−VH)×CH−{(Vsig−ΔV′−VCOM)((CLC1+CST1)+ . . . +(CLCmn+CSTmn))+(Vsig−ΔV′−VL)×CL+(Vsig−ΔV′−VH)×CH} Equation 33

In a case of Vsig−ΔV′=A, Equations 33 is organized as the following Equation 34.

$$( VON - VOFF - Δ {V}^{′} ) \times ( Cgd 1 + … + Cgdmn ) = ( Vsig - VCOM ) ( ( CLC 1 + CST 1 ) \} + … + ( CLCmn + CSTmn ) ) + ( Vsig - VL ) \times CL + ( Vsig - VH ) \times CH - ( A - COM ) ( ( CLC 1 + CST 1 ) \} + … + ( CLCmn + CSTmn ) ) - ( A - VL ) \times CL - ( A - VH ) \times CH = ( Vsig - A ) ( ( CLC 1 + CST 1 ) + … + ( CLCmn + CSTmn ) ) + ( Vsig - A ) \times CL + ( Vsig - A ) \times CH = ( Vsig - A ) \{ ( ( CLC 1 + CST 1 ) + … + ( CLCmn\_CSTmn ) ) + CL + CH \} \qquad Equation 34$$

In a case of A=Vsig−ΔV′, Equation 34 is organized as the following Equation 35.

(VON−VOFF−ΔV′)×(Cgd1+ . . . +Cgdmn)=ΔV′{((CLC1+CST1)+ . . . +(CLCmn+CSTmn))+CL+CH} Equation 35

Therefore, the kickback voltage ΔV′ is induced as the following Equation 36.

ΔV′=(VON−VOFF)×(Cgd1+ . . . +Cgdmn)/{((CLC1+CST1)+ . . . +(CLCmn+CSTmn))+CL+CH) Equation 36

Equation 36 is organized as the following Equation 37,

ΔV′=Σ[i=1,mn]Cgdi(VON−VOFF)/{Σ[i=1,mn]((CLCi+CSTi+Cgdi)+(CL+CH))} Equation 37

On the assumption that the capacitance values of the parasitic capacitances Cgd1 to Cgdm and Cgdm1 to Cgdmn) are the same as “Cgd”, e.g., Cgd1= . . . =Cgdmn=Cgd, the capacitance values of the liquid crystal capacitors CLC1 to CLCm and CLCm1 to CLCm are the same as “CLC”, e.g., CLC1= . . . =CLCmn=CLC, the capacitance values of the storage capacitors CST1 to CSTm and CSTm1 to CSTmn are the same as “CST”, e.g., CST1= . . . =CSTmn=CST, and the number of the dummy pixels DPX1 to DPXm and DPXm1 to DPXmn is “S”, Equation 37 may be rewritten as the following Equation 38.

ΔV′=S×Cgd(VON−VOFF)/{S×(CLC+CST+Cgd)+(CL+CH) Equation 38

In Equation 22, since ΔV=(VON−VOFF)×Cgd/(CLC+CST+CL+CH+Cgd), (VON−VOFF)×Cgd/(CLC+CST+CL+CH+Cgd)≈S×Cgd(VON−VOFF)/{S×(CLC+CST+Cgd)+(CL+CH)

Accordingly, ΔV≈ΔV′

That is, when the dummy pixels satisfy Equation of Σ[i=1, mn]((CLCi+CSTi+Cgdi)>>(CL+CH)), the kickback voltage ΔV may be obtained.

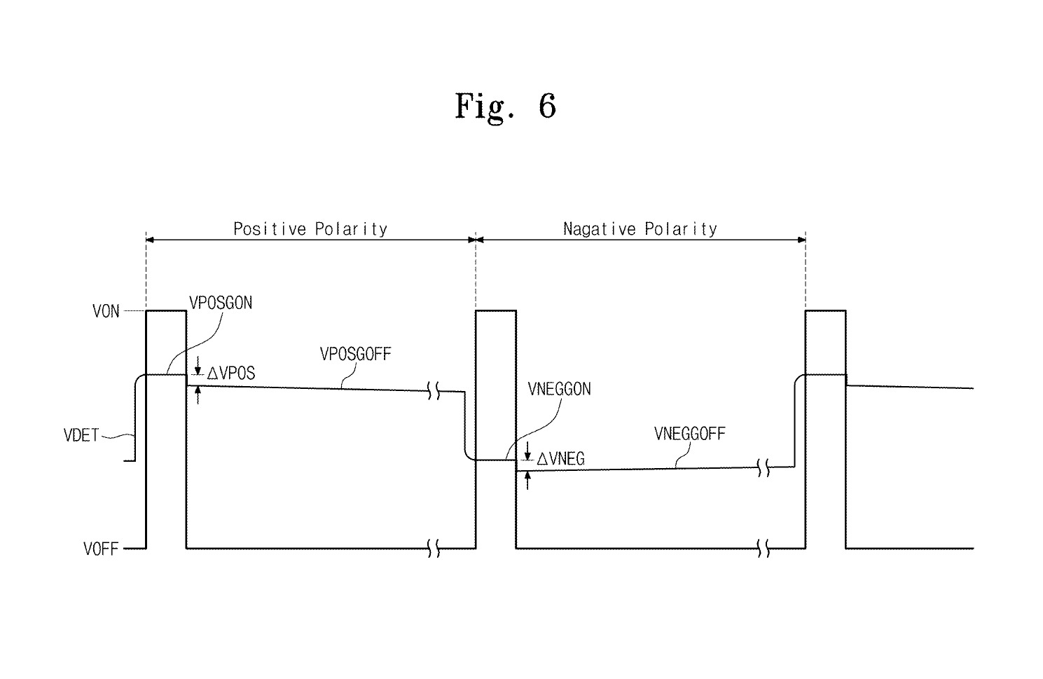

FIG. 6 is a view showing signals output from the buffer shown in FIG. 5 in the test mode.

In FIGS. 5 and 6, when the gray-scale voltage used to drive the data lines D1 to Dm and the tummy data line Dm+1 is the positive (+) polarity, a voltage output from the buffer 212 while the first and second dummy gate lines Gn+1 and Gn+2 are driven by the gate-on voltage VON is referred to as a first voltage VPOSGON, and a voltage output from the buffer 212 while the first and second dummy gate lines Gn+1 and Gn+2 are driven by the gate-off voltage VOFF is referred to as a second voltage VPOSGOFF. When the gray-scale voltage used to drive the data lines D1 to Dm and the tummy data line Dm+1 is the negative (−) polarity, a voltage output from the buffer 212 while the first and second dummy gate lines Gn+1 and Gn+2 are driven by the gate-on voltage VON is referred to as a third voltage VNEGSGON, and a voltage output from the buffer 212 while the first and second dummy gate lines Gn+1 and Gn+2 are driven by the gate-off voltage VOFF is referred to as a fourth voltage VNEGGOFF. In the case of the positive (+) polarity, a kickback voltage ΔVPOS as the following Equation 39, and in the case of the negative (−) polarity, a kickback voltage ΔVNEG as the following Equation 40 are obtained.

ΔVPOS=VPOSGON−VPOSGOFF Equation 39

ΔVNEG=VNEGGON−VNEGGOFF Equation 40

Therefore, an average kickback voltage ΔV is as the following Equation 41.

ΔV=(ΔVPOS−ΔVNEG)/2 Equation 41

The first and third voltages VPOSGON and VNEGGON output from the buffer 212 while the first and the second dummy gate lines Gn+1 and Gn+2 are driven by the gate-on voltage VON have the voltage level corresponding to the test data TDATA provided to the data lines D1 to Dm and the dummy data line Dm+1. That is, the first and third voltages VPOSGON and VNEGGON may be obtained from the test data TDATA. Thus, the kickback voltage ΔV may be obtained by measuring the second and fourth voltages VPOSGOFF and VNEGOFF output from the buffer 212 while the first and second dummy gate lines Gn+1 and Gn+2 are driven by the gate-off voltage VOFF.

In the test mode, the third control signal CONT3 is activated to the high level while the first and second dummy gate lines Gn+1 and Gn+2 are driven by the gate-off voltage VOFF. Accordingly, when the dummy switching transistors DT1 to Dtm and DTm1 to DTmn are turned off, the analog detecting voltage VDET output from the buffer 212 may be applied to the analog-to-digital converter 220. When the switch 214 is turned on in response to the third control signal CONT3, the analog detecting voltage VDET applied to the analog-to-digital converter 220 may be the second and fourth voltages VPOSGOFF and VNEGOFF.

The analog-to-digital converter 220 converts the analog detecting voltage VDET to the digital detecting signal DET using the gamma voltages V1 to Vk generated by the gamma voltage generator 170 shown in FIG. 1. The data driver 130 shown in FIG. 1 drives the data lines D1 to Dm and the dummy data line Dm+1 using the gray-scale voltages corresponding to the image data DATA using the gamma voltages V1 to Vk. In this case, a relation between the image data DATA and the driving voltage for the data lines D1 to Dm is non-linear. Therefore, the analog-to-digital converter 220 is required to using the gamma voltages V 1 to Vk so as to convert the analog detecting voltage VDET to the digital detecting signal DET. According to another embodiment, the analog-to-digital converter 220 may include a memory, e.g., a look-up table, instead of referring to the gamma voltages V1 to Vk so as to output the digital detecting signal DET corresponding to the analog detecting voltage VDET.

The kickback output circuit 230 outputs a kickback voltage KB corresponding to a difference between the digital detecting signal DET and the test data TDATA from the timing controller 120. As described above, the test data TDATA corresponds to the first and third voltages VPOSGON and VNEGGON output from the buffer 212 while the first and second dummy gate lines Gn+1 and Gn+2 are driven by the gate-on voltage VON.

Therefore, the kickback signal KB output from the kickback output circuit 230 correspond to the kickback voltage ΔV obtained from the kickback voltage ΔVPOS corresponding to the difference between the first and second voltages VPOSGON and VPOSGOFF in the case of the positive (+) polarity and the kickback voltage ΔVNEG corresponding to the difference between the third and fourth voltages VNEGGON and VNEGGOFF in the case of the negative (−) polarity (refer to Equations 39 and 41).

The voltage generator 140 shown in FIG. 1 controls the voltage level of the common voltage VCOM in response to the kickback signal KB. Accordingly, the voltage generator 140 may control the voltage level of the common voltage VCOM to compensate for the kickback voltage ΔV.

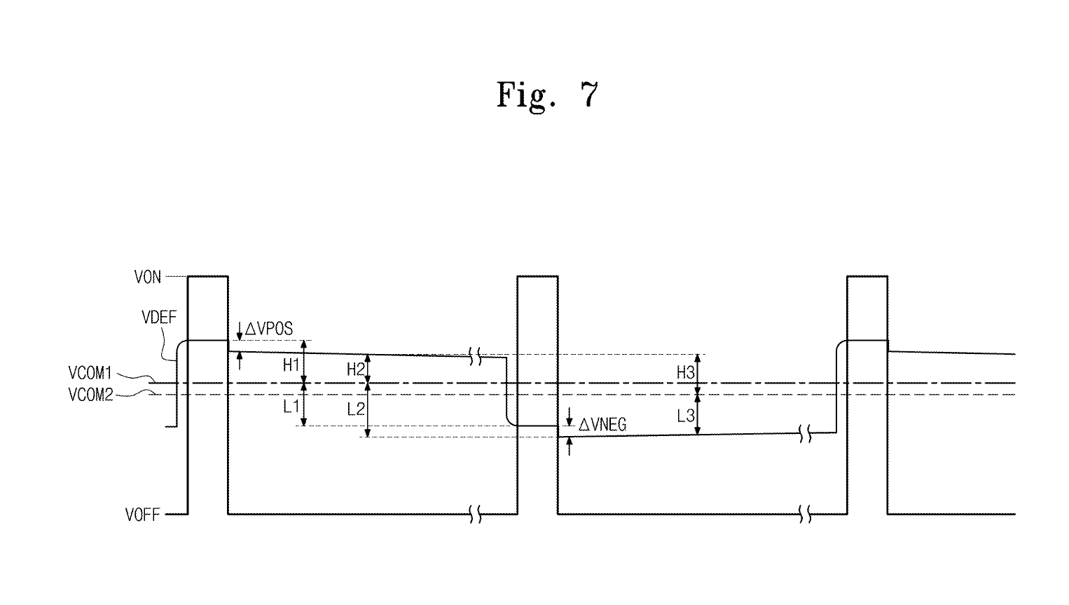

FIG. 7 is a view showing the analog detecting voltage output from the buffer shown in FIG. 5 in accordance with the level of the common voltage generated by the voltage generator shown in FIG. 1.

Referring to FIG. 7, the voltage generator 140 generates the common voltage VCOM having a first level VCOM1 corresponding to the intermediate level between the positive (+) polarity gray-scale voltage and the negative (−) polarity gray-scale voltage, which are used to drive the data lines D1 to Dm and the dummy data lines Dm+1. Ideally, a difference H1 between the positive (+) polarity analog detecting voltage VDET output from the buffer 212 shown in FIG. 5 and the common voltage VCOM is the same as a difference L1 between the negative (−) polarity analog detecting voltage VDET and the common voltage VCOM (H1=L1).

However, in the case that the voltage level of the positive (+) polarity analog detecting voltage VDET and the negative (−) polarity analog detecting voltage VDET is lowered by the kickback voltages ΔVPOS and ΔVNEG, a difference H2 between the positive (+) polarity analog detecting voltage VDET and the common voltage VCOM having the first level VCOM1 is different from a difference L2 between the negative (−) polarity analog detecting voltage VDET and the common voltage VCOM having the first level VCOM1 (H2<L2).

The voltage generator 140 controls the voltage level of the common voltage VCOM to a second level VCOM2 in response to the kickback signal KB. Therefore, a difference H3 between the positive (+) polarity analog detecting voltage VDET and the common voltage VCOM having the second level VCOM2 becomes equal to a difference L3 between the negative (−) polarity analog detecting voltage VDET and the common voltage VCOM (H3=L3). As described above, when the voltage level of the common voltage VCOM is controlled by the kickback voltages ΔVPOS and ΔVNEG, a flicker on the screen of the display panel 110 may be reduced.

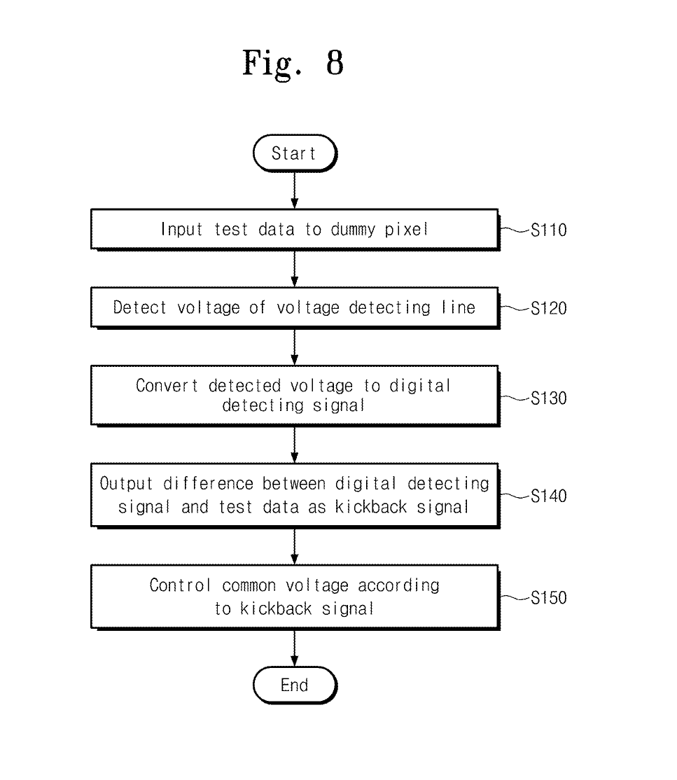

FIG. 8 is a flowchart showing a method of operating a display device shown in FIG. 1 according to an exemplary embodiment of the present invention.

Referring to FIGS. 1, 2, and 8, the timing controller 120 provides the test data TDATA to the dummy pixels DPX1 to DPXm and DPXm1 to DPXmn in the dummy area 114 when the display device 100 is operated in the test mode (S110). In this case, the timing controller 120 controls the gate driver 150 to drive the first and second dummy gate lines Gn+1 and Gn+2.

When the gate-on voltage VON and the gate-off voltage VOFF are sequentially applied to the first and second dummy gate lines Gn+1 and Gn+2, the detected voltage VD of the voltage detecting line VDL is applied to the kickback detector 160. The kickback detector 160 detects the detected voltage VD of the analog detecting line VDL in response to the third control signal CONT3 (S120).

The analog-to-digital converter 220 of the kickback detector 160 converts the analog detecting voltage VDET to the digital detecting signal DET using the gamma voltages V1 to Vk (S130). The kickback output circuit 230 in the kickback detector 160 outputs the kickback signal KB corresponding to the difference between the digital detecting signal DET and the test data TDATA to the voltage generator 140 (S140). The voltage generator 140 controls the voltage level of the common voltage VCOM in accordance with the kickback signal KB (S150).

According to the above-mentioned method, the kickback voltage ΔV may be obtained from the detected voltage VD output through the voltage detecting line VDL of the dummy pixels DPX1 to DPXm and DPXm1 to DPXmn, and thus the voltage level of the common voltage VCOM may be controlled.

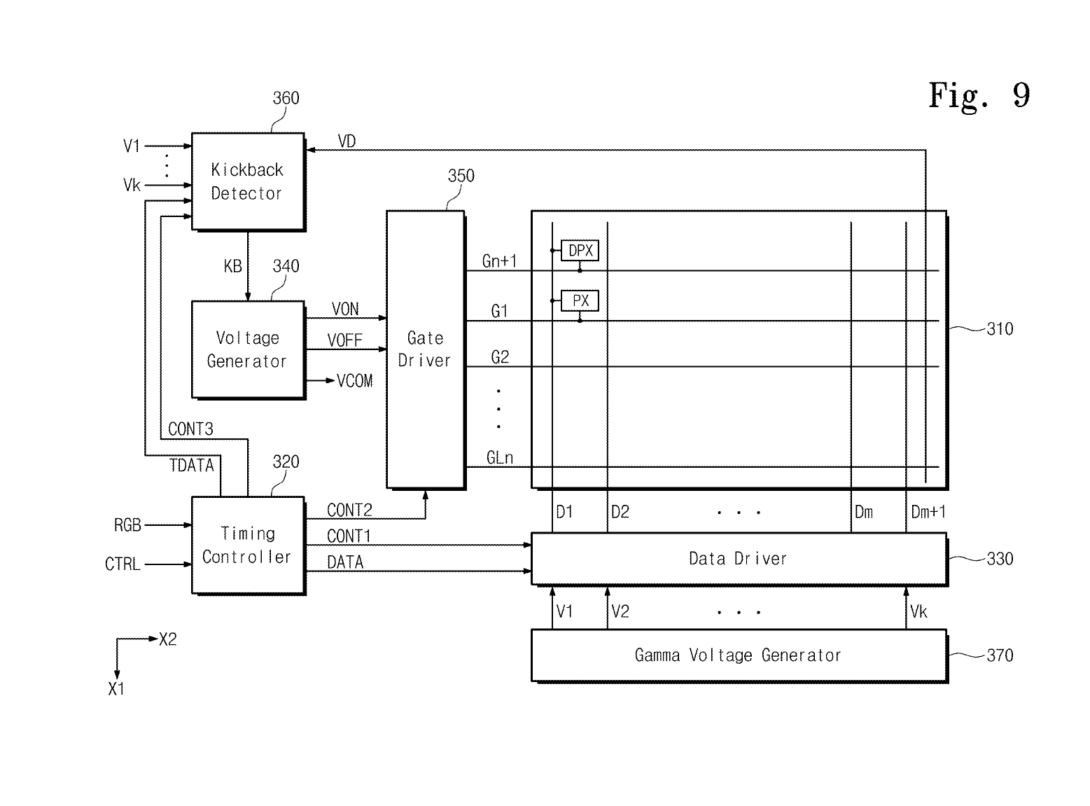

FIG. 9 is a block diagram showing a display device according to another exemplary embodiment of the present invention.

Referring to FIG. 9, a display device 300 includes a display panel 310, a timing controller 320, a data driver 330, a voltage generator 340, a gate driver 350, a kickback detector 360, and a gamma voltage generator 370.

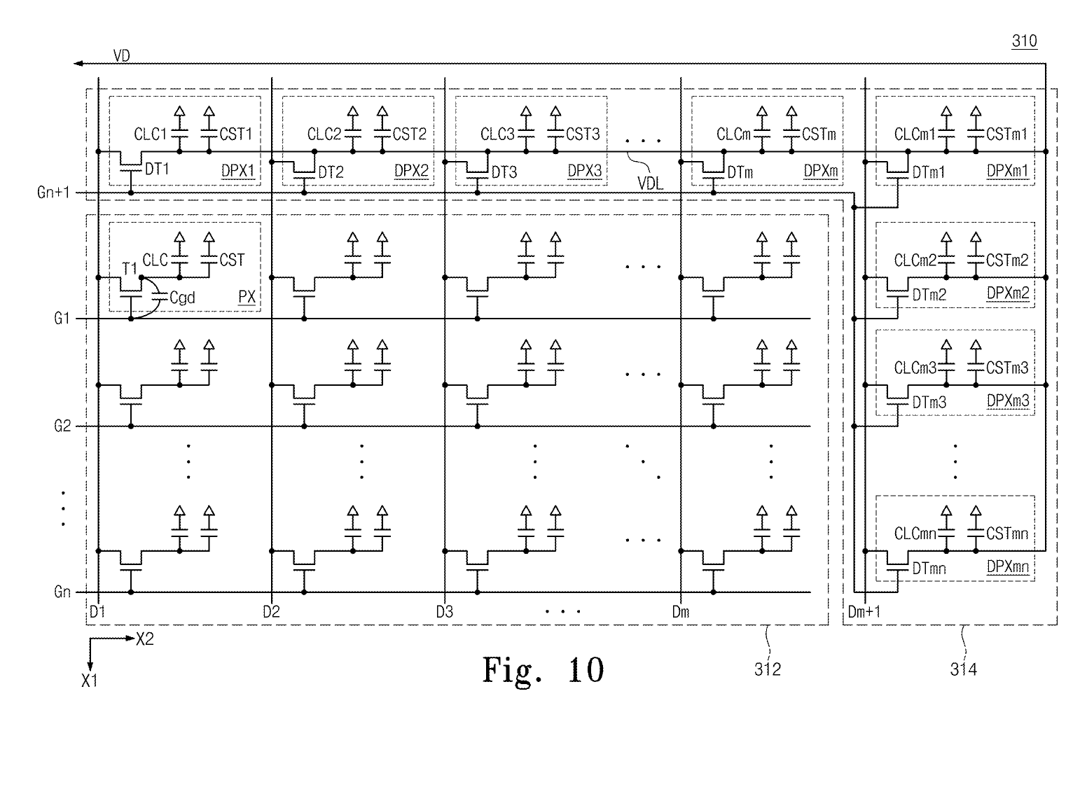

The display panel 310 includes a plurality of data lines D1 to Dm, a dummy data line Dm+1, a plurality of gate lines G1 to Gn, and a dummy gate line Gn+1. Different from the display panel 110 shown in FIG. 1, the display panel 310 shown in FIG. 9 includes one dummy gate line Gn+1. The data lines D1 to Dm and the dummy data line Dm+1 are extended in a first direction X1. The gate lines G1 to Gn and the dummy gate line Gn+1 are extended in a second direction X2 to cross the data lines D1 to Dm and the dummy data line Dm+1. The configuration and arrangement of the display panel 310 will be described in detail with reference to FIG. 10.

FIG. 10 is a circuit diagram showing the arrangement of pixels and dummy pixels of the display panel shown in FIG. 9.

Referring to FIG. 10, the display panel 310 includes a display area 312 in which a plurality of pixels are arranged and a dummy area 314 in which a plurality of dummy pixels DPX are arranged. In FIG. 10, the dummy area 314 is located in upper and right portions of the display area 312. The position of the dummy area 314 should not be limited to the upper and right portions of the display area 312. For instance, the dummy area 314 may be located in upper and left portions, lower and left portions, lower and right portions, or upper and lower portions of the display area 312.

The arrangements of the data lines D1 to Dm, the gate lines G1 to Gn, and the pixels PX in the display area 312 are similar to those of the display area 112 shown in FIG. 2. The dummy area 314 includes a plurality of dummy pixels DPX1 to DPXm and DPXm1 to DPXmn. The dummy pixels DPX1 to DPXm and DPXm1 to DPXmn are divided into first dummy pixels DPX1 to DPXm and second dummy pixels DPXm1 to DPXmn. The first dummy pixels DPX1 to DPXm are located in the upper portion of the display area 312 and sequentially arranged in the second direction X2 in which the dummy gate line Gn+1 extends. The second dummy pixels DPXm1 to DPXmn are located in the right portion of the display area 312 and are sequentially arranged in the first direction X1 in which the dummy data line Dm+1 extends.

Each of the first dummy pixels DPX1 to DPXm and each of the second dummy pixels DPXm1 to DPXmn include a dummy switching transistor, a dummy liquid crystal capacitor, and a dummy storage capacitor. For instance, the first dummy pixel DPX1 includes the dummy switching transistor DT1, the dummy liquid crystal capacitor CLC1, and the dummy storage capacitor CST1. The first dummy pixel DPX2 includes the dummy switching transistor DT2, the dummy liquid crystal capacitor CLC2, and the dummy storage capacitor CST2. The second dummy pixel DPXm1 includes the dummy switching transistor DTm1, the dummy liquid crystal capacitor CLCm1, and the dummy storage capacitor CSTm1. The second dummy pixel DPXmn includes the dummy switching transistor DTmn, the dummy liquid crystal capacitor CLCmn, and the dummy storage capacitor CSTmn.

Each of the dummy switching transistors DT1 to DTm of the first dummy pixels DPX1 to DPXm includes a source terminal connected to a corresponding data line of the data lines D1 to Dm, a drain terminal connected to a voltage detecting line VDL, and a gate terminal connected to the dummy gate line Gn+1. A first terminal of the dummy liquid crystal capacitors CLC1 to CLCm and the storage capacitors CST1 to CSTm of the first dummy pixels DPX1 to DPxm is connected to the voltage detecting line VDL and a second terminal of the dummy liquid crystal capacitors CLC1 to CLCm and the storage capacitors CST1 to CSTm of the first dummy pixels DPX1 to DPXm is connected to a common voltage VCOM of the voltage generator 140 shown in FIG. 9.

Each of the dummy switching transistors DTm1 to DTmn of the second dummy pixels DPXm1 to DPXmn includes a source terminal connected to the dummy data line Dm+1, a drain terminal connected to the voltage detecting line VDL, and a gate terminal connected to the dummy gate line Gn+1. A first terminal of the dummy liquid crystal capacitors CLCm1 to CLCmn and the storage capacitors CSTm1 to CSTmn of the second dummy pixels DPXm1 to DPxmn is connected to the voltage detecting line VDL and a second terminal of the dummy liquid crystal capacitors CLCm1 to CLCmn and the storage capacitors CSTm1 to CSTmn of the second dummy pixels DPXm1 to DPXmn is connected to the common voltage VCOM of the voltage generator 140 shown in FIG. 10. The detected voltage VD of the voltage detecting line VD is applied to the kickback detector 360.

The display device 300, which includes the display panel 310 shown in FIG. 9, may figure out the kickback voltage ΔV on the basis of the detected voltage VD output through the voltage detecting line VDL of the dummy pixels DPX1 to DPXm and DPXm1 to DPXmn, and the voltage level of the common voltage VCOM may be controlled in accordance with the kickback voltage ΔV.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display device comprising:
a plurality of pixels arranged in a matrix array on a substrate;
a plurality of dummy pixels each of which has a dummy gate line, and a dummy data line or one of a plurality of data lines;
a gate driver configured to drive a plurality of gate lines and the dummy gate line;
a data driver configured to drive the plurality of data lines and the dummy data line;
a timing controller configured to control the gate driver to drive the dummy gate line and the data driver to drive the dummy data line, and configured to apply a test data to the data driver during a test mode;
a kickback detector configured to output a kickback signal corresponding to a difference between the test data from the timing controller and detected voltage from the dummy pixel during the test mode; and
a voltage generator configured to control a level of a common voltage in accordance with the kickback signal,
wherein first dummy pixels of the plurality of dummy pixels are sequentially arranged in a direction in which the plurality of gate lines are extended and second dummy pixels of the plurality of dummy pixels are sequentially arranged in a direction in which the plurality of data lines are extended.

2. The display device of claim 1, wherein the timing controller controls the gate driver, the data driver and the kickback detector in response to an image signal and control signals during the test mode.

3. The display device of claim 1, wherein each of the plurality of dummy pixels comprises:
a dummy transistor connected to the one of a plurality of data lines or the dummy data line, a detecting line, and the dummy gate line;
a dummy liquid crystal capacitor connected between the detecting line and the common voltage; and
a dummy storage capacitor connected between the detecting line and the common voltage.

4. The display device of claim 1, wherein the dummy gate line comprises a first dummy gate line connected to the first dummy pixels and a second dummy gate line connected to the second dummy pixels.

5. The display device of claim 4, wherein each of the first dummy pixels of the plurality of dummy pixels comprises:
a first dummy transistor connected to a corresponding data line of the plurality of data lines, a detecting line, and the first dummy gate line;
a first dummy liquid crystal capacitor connected between the detecting line and the common voltage; and
a first dummy storage capacitor connected between the detecting line and the common voltage.

6. The display device of claim 5, wherein each of the second dummy pixels of plurality of the dummy pixels comprises:
a second dummy transistor connected to the dummy data line, the detecting line, and the second dummy gate line;
a second dummy liquid crystal capacitor connected between the detecting line and the common voltage; and
a second dummy storage capacitor connected between the detecting line and the common voltage.

7. The display device of claim 6, wherein the gate driver drives the first and the second dummy gate lines using a gate-on voltage and a gate-off voltage during the test mode and the first and second dummy gate lines are substantially simultaneously driven.

8. The display device of claim 6, wherein the kickback detector comprises:
a buffer including an input terminal connected to the detecting line and an output terminal;
a switching circuit connected to the output terminal and configured to output a voltage of the output terminal of the buffer as an analog detecting voltage in response to a test mode signal from the timing controller;
an analog-to-digital converter connected to the switching circuit and configured to convert the analog detecting voltage to a digital detecting signal; and
a kickback output circuit connected to the analog-to-digital converter and configured to output a difference between the digital detecting signal and the test data as the kickback signal.

9. The display device of claim 8, wherein the test mode signal is activated while the first and the second dummy gate lines are driven by the gate-off voltage.

10. The display device of claim 9, wherein the timing controller provides an image data to the data driver during the normal mode in response to an image signal and a control signal and provides a test data to the data driver during the test mode.

11. The display device of claim 10, further comprising a gray-scale voltage generator configured to generate a plurality of gray-scale voltages,
wherein the data driver drives the plurality of data lines and the dummy data line using a gray-scale voltage corresponding to the test data during the test mode.

12. The display device of claim 11, wherein the analog-to-digital converter converts the analog detecting voltage to a digital detecting signal with reference to the gray-scale voltages from a gamma voltage generator.

13. A method of operating a display device comprising:
applying a test data to a plurality of dummy pixels connected to a plurality of data lines and a dummy data line;
driving a dummy gate line;
detecting a voltage of a voltage detecting line to which the plurality of dummy pixels are commonly connected;
converting the detected analog voltage of the voltage detecting line to a digital detecting signal;
outputting a difference between the digital detecting signal and the test data as a kickback signal; and
controlling a voltage level of a common voltage in accordance with the kickback signal.

14. The method of claim 13, further comprising:
comparing the digital detecting signal with the test data provided by the timing controller.

15. The method of claim 14, wherein the controlling a voltage level of a common voltage comprises:
detecting a positive polarity analog detecting voltage and a negative polarity analog detecting voltage, and
adjusting the common voltage to be a middle value of the positive polarity analog detecting voltage and a negative polarity analog detecting voltage.

16. The method of claim 15, wherein the converting the detected analog voltage of the voltage detecting line to a digital detecting signal uses a look-up table or a gamma voltage generated by a gamma voltage generator.

17. The method of claim 13, wherein the controlling a voltage level of a common voltage comprises:
detecting a positive polarity analog detecting voltage and a negative polarity analog detecting voltage, and
setting the common voltage to be a middle value of the positive polarity analog detecting voltage and a negative polarity analog detecting voltage.

18. The method of claim 17, wherein the converting the detected analog voltage of the voltage detecting line to a digital detecting signal uses a look-up table or a gamma voltage generated by a gamma voltage generator.

19. The method of claim 13, wherein the converting the detected analog voltage of the voltage detecting line to a digital detecting signal uses a look-up table or a gamma voltage generated by a gamma voltage generator.
